(19) United States
(12) Patent Application Publication
(10) Pub. No.: US 2025/0102807 A1
(43) Pub. Date: Mar. 27, 2025

(54) ELECTRONIC DEVICE FOR TRACKING USER'S GAZE

(71) Applicant: SAMSUNG ELECTRONICS CO., LTD., Suwon-si (KR)

(72) Inventors: Jeonggeun YUN, Suwon-si (KR); Youngmo Jeong, Suwon-si (KR); Jongchul Choi, Suwon-si (KR); Bonkon Koo, Suwon-si (KR)

(73) Assignee: SAMSUNG ELECTRONICS CO., LTD., Suwon-si (KR)

(21) Appl. No.: 18/896,216

(22) Filed: Sep. 25, 2024

Related U.S. Application Data
(63) Continuation of application No. PCT/KR2024/012906, filed on Aug. 28, 2024.

(30) Foreign Application Priority Data
Sep. 25, 2023 (KR) 10-2023-0128489

(51) Int. Cl. G02B 27/01; B82Y 20/00; G02B 1/00; G02B 27/00

(52) U.S. Cl. CPC G02B 27/0172; B82Y 20/00; G02B 1/002; G02B 27/0093; G02B 2027/0138; G02B 2027/014

(57) ABSTRACT

An electronic device, including: an infra-red (IR) light source configured to output infrared light; a waveguide; a first optical element on a first area of the waveguide, wherein the first optical element is configured to allow external light to enter the waveguide; a second optical element on a second area of the waveguide, wherein the second optical element is configured to output the external light incident to an outside of the waveguide; a third optical element on a third area of the waveguide, wherein the third area is different from the first area and the second area, and wherein the third optical element is configured to diffract the infrared light; and an image sensor configured to receive the diffracted infrared light

### CROSS-REFERENCE TO RELATED APPLICATIONS

This application is a continuation of International Application No. PCT/KR2024/012906, filed on Aug. 28, 2024, in the Korean Intellectual Property Receiving Office, which is based on and claims priority to Korean Provisional Application Number 10-2023-0128489 filed on Sep. 25, 2023, in the Korean Intellectual Property Office, the disclosures of which are incorporated by reference herein in their entireties.

### BACKGROUND

### 1. Field

The disclosure relates to an electronic device for tracking a user's gaze, and more particularly to an electronic device for tracking a user's gaze through a miniaturized camera module arranged on a waveguide.

### 2. Description of Related Art

An augmented reality device may refer to a device that provides augmented reality (AR), for example AR glasses. A first optical system of the augmented reality device may include a display engine (projector, etc.) that outputs an image, and a waveguide that sends the output image to the eyes. An image emitted from the display engine may be transmitted to the eyes through the waveguide, allowing a person to view the image.

A wearable display device may refer to a device that allows a person to view a displayed screen while wearing the device. Wearable glasses or head mounted displays are examples of such wearable display devices. In order for an augmented reality device to be used as a wearable display device, it may be desirable for the augmented reality device to have an appearance that does not cause discomfort to general users.

### SUMMARY

In accordance with an aspect of the disclosure, an electronic device includes: an infra-red (IR) light source configured to output infrared light; a waveguide; a first optical element on a first area of the waveguide, wherein the first optical element is configured to allow external light to enter the waveguide; a second optical element on a second area of the waveguide, wherein the second optical element is configured to output the external light incident to an outside of the waveguide; a third optical element on a third area of the waveguide, wherein the third area is different from the first area and the second area, and wherein the third optical element is configured to diffract the infrared light; and an image sensor configured to receive the diffracted infrared light.

In accordance with an aspect of the disclosure, a waveguide image combiner includes: a waveguide; a first optical element on a first area of the waveguide, wherein the first optical element is configured to allow external light to enter the waveguide; a second optical element located on a second area of the waveguide, wherein the second optical element is configured to output the external light to an outside of the waveguide; and a third optical element on a third area of the waveguide, wherein the third area is different from the first area and the second area, and wherein the third optical element is configured to diffract infrared light output from a light source.

In accordance with an aspect of the disclosure, an augmented reality device includes: a display engine configured to output image light; and a waveguide image combiner, including: a waveguide; a first optical element on a first area of the waveguide, wherein the first optical element is configured to allow external light to enter the waveguide; a second optical element located on a second area of the waveguide, wherein the second optical element is configured to output the external light to an outside of the waveguide; and a third optical element on a third area of the waveguide, wherein the third area is different from the first area and the second area, wherein the third optical element is configured to diffract infrared light output from a light source, wherein the waveguide image combiner is configured to guide the image light to a target area, and wherein the target area includes an eye motion box of a user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of a user wearing an electronic device according to an embodiment of the disclosure;

FIG. 2 is a diagram illustrating operation of an electronic device according to an embodiment of the disclosure;

FIG. 3 is an inner side view of a portion of an electronic device for describing the arrangement of a third optical element and an image sensor, according to an embodiment of the disclosure;

FIG. 4 is a side view of an electronic device according to an embodiment of the disclosure;

FIG. 5 is a conceptual diagram illustrating an operation of tracking a user's gaze, according to an embodiment of the disclosure;

FIG. 6 is a conceptual diagram illustrating an operation of tracking a user's gaze, according to an embodiment of the disclosure;

FIG. 7 is a conceptual diagram illustrating an operation of tracking a user's gaze, according to an embodiment of the disclosure;

FIG. 8 is an inner side view of a portion of an electronic device for describing the arrangement of a third optical element and an image sensor, according to an embodiment of the disclosure;

FIG. 9 is an inner side view of a portion of an electronic device for describing the arrangement of a third optical element and an image sensor, according to an embodiment of the disclosure;

FIG. 10 is an inner side view of a portion of an electronic device for describing the arrangement of a third optical element and an image sensor, according to an embodiment of the disclosure;

FIG. 11 is an inner side view of a portion of an electronic device for describing the arrangement of a third optical element and an image sensor, according to an embodiment of the disclosure;

FIG. 12 is a conceptual diagram for describing a third optical element according to an embodiment of the disclosure;

FIG. 13 is a flowchart illustrating an operating method of an electronic device, according to an embodiment of the disclosure;

FIG. 14 is a flowchart illustrating an operating method of an electronic device, according to an embodiment of the disclosure;

FIG. 15 is a flowchart illustrating an operating method of an electronic device, according to an embodiment of the disclosure; and

FIG. 16 is a block diagram illustrating components of an electronic device, according to an embodiment of the disclosure.

### DETAILED DESCRIPTION

The terms used to describe embodiments of the disclosure are general terms that are currently widely used as much as possible while considering the function of the disclosure, but this may vary depending on the intention or precedent of a person working in the art, the emergence of new technology, etc. In addition, in certain cases, there are terms arbitrarily selected by the applicant, and in this case, the meaning will be described in detail in the description of the relevant embodiment of the disclosure. Therefore, the terms used herein should be understood based on the meaning of the term and the overall content of the disclosure, rather than simply the name of the term.

Singular expressions may include plural expressions, unless the context clearly dictates otherwise. Terms used herein, including technical or scientific terms, may have the same meaning as generally understood by a person of ordinary skill in the technical field described herein.

Throughout the disclosure, when a part “comprises” or “includes” an element in the specification, unless otherwise defined, other elements are not excluded from the part and the part may further include other elements. In addition, terms such as “ . . . unit” and “ . . . module” used in this specification may refer to a unit that processes at least one function or operation, which may be implemented as hardware or software or as a combination of hardware and software.

The expression “configured to” used in the disclosure may be interchangeably used with, for example, “suitable for,” “having the capacity to,” “designed to,” “adapted to,” “made to,” or “capable of,” depending on the situation. The term “configured (or set to)” may not necessarily mean “specifically designed to” in hardware. Instead, in some contexts, the expression “system configured to” may mean that the system is “capable of” in conjunction with other devices or components. For example, the phrase “processor configured (or set) to perform A, B, and C” refers to a processor dedicated to performing the operations (e.g., an embedded processor), or a general-purpose processor (e.g., CPU or application processor) that can perform the corresponding operations by executing one or more software programs stored in a memory.

In addition, in the disclosure, when a component is referred to as “connected” to another component, the component may be directly connected to the other component, but unless the context clearly indicates otherwise, it should be understood that the component may be connected through another component.

Throughout the disclosure, the expression “at least one of a, b or c” may indicate only a, only b, only c, both a and b, both a and c, both b and c, all of a, b, and c, or variations thereof.

Below, with reference to the attached drawings, embodiments of the disclosure are described in detail so that those of skill in the art may easily practice them. However, the disclosure may be implemented in many different forms and is not limited to the embodiment of the disclosure described herein.

In this disclosure, light may include first light, second light, and third light. The first light may include light of a virtual image output from the display portion. The second light may include light output from a light source and reflected by the eyes of a user. The second light may include light in the infrared band and may also be referred to as infrared light. The third light may include light that may be naturally generated, excluding the first light and the second light. The third light may include natural light as noise that is not generated by the electronic device according to an embodiment of the disclosure.

Hereinafter, the embodiments of the disclosure are described in detail with reference to the drawings.

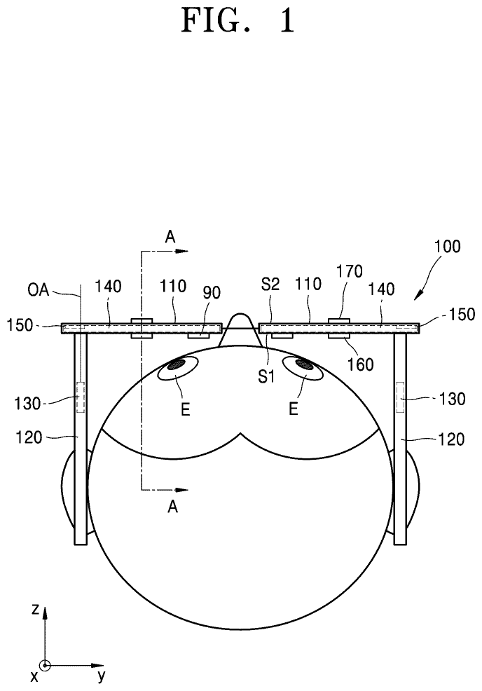

FIG. 1 illustrates an example of a user wearing an electronic device according to an embodiment of the disclosure.

Referring to FIG. 1, an electronic device 100 according to an embodiment of the disclosure may be a glasses-type display device configured to be worn by a user, and may be for example augmented reality glasses.

The electronic device 100 may include a glasses-type body having a frame 110 and temples 120. The frame 110 may have, for example, a shape of two rims connected by a bridge. The rims and the bridge of the frame 110 may not be distinguished or differentiated. The temples 120 may be respectively connected to both ends of the frame 110 and may extend in one direction. Both ends of the frame 110 and the temples 120 may be connected to each other, for example, by a hinge. As another example, the frame 110 and the temples 120 may be integrally connected.

The display portion 130 may be mounted on the glasses-type body. The display portion 130 may be configured to output first light including a virtual image. In an embodiment of the disclosure, the display portion 130 may be a projector configured to output the first light.

In an embodiment of the disclosure, the display portion 130 may be mounted on the temples 120. In an embodiment of the disclosure, the display portion 130 may be mounted on the temple 120 such that a direction of an optical axis OA of light output from the display portion 130 is the same as the longitudinal direction of the temple 120, but embodiments are not limited thereto. As another example, a portion of the display portion 130 may be fixed to the temple 120, and another portion of the display portion 130 may be fixed to the frame 110 (e.g., on a rim shape of the frame 110). When the frame 110 and the temples 120 are formed as one body, the mounting location of the display portion 130 may not be divided into the frame 110 and the temples 120. The display portion 130 may be provided for each of the left and right eyes, or may be provided on only one side.

A waveguide 140 may be mounted on the frame 110. The waveguide 140 may be configured to transmit the first light of the virtual image generated by the display portion 130 and light of an external scene to the user's pupil. The waveguide 140 may have a flat shape. The waveguide 140 may be formed as a single-layer or multi-layer structure of a transparent material through which light may be internally reflected to be propagated. Here, a transparent material may refer to a material through which light in the visible light band may pass, and the transparency thereof may not be 100%, and the transparent material may have a certain color. Because the waveguide 140 may include a transparent material, the user may view virtual images through the electronic device 100, and may also view real scenes, and thus the electronic device 100 may implement or provide an augmented reality experience to a user. The waveguide 140 may be provided on each of the left and right eyes corresponding to the display portion 130, or may be provided on only one side.

In an embodiment of the disclosure, eyeglasses may be located on the frame 110. In this case, the waveguide 140 may be attached to the eyeglasses or fixed to the frame 110 separately from the eyeglasses. The eyeglasses may also be omitted.

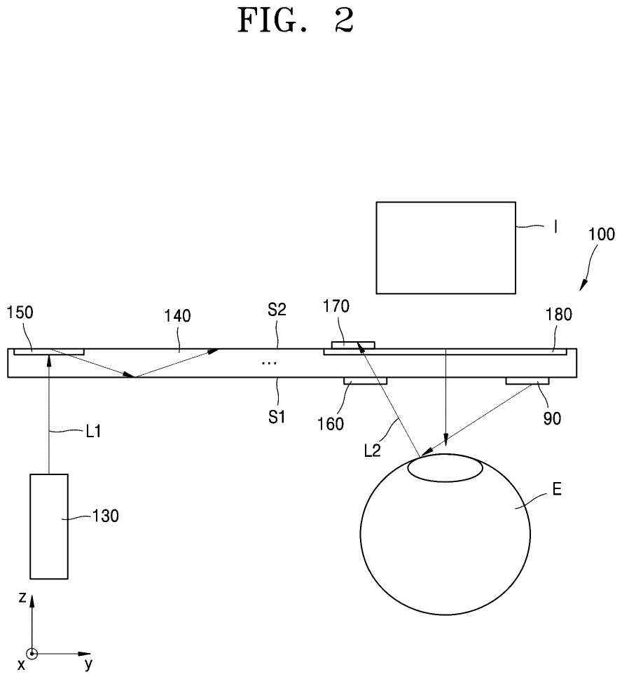

A first optical element 150 may be located on one side of the waveguide 140 located on the optical axis OA of the display portion 130. The first optical element 150 may be located on a first surface of the waveguide 140, the first surface facing the display portion 130, or on a second surface opposite the first surface, or inside the waveguide 140 (or, for example in the case of a multilayer waveguide, between multiple layers), and may allow the first light (e.g., the first light L1 illustrated in FIG. 2) output from the display portion 130, to be input to the waveguide 140. The first optical element 150 may include an input-coupler that diffracts the first light L1 and inputs the same into the waveguide 140.

The first optical element 150 may be a diffractive element that propagates the first light into the waveguide 140. The diffractive element may be implemented as at least one of a diffractive optical element (DOE), a holographic optical element (HOE), polymer dispersed liquid crystals (PDLC), a metasurface, etc.

A second optical element (e.g., the second optical element 180 illustrated in FIG. 2) may be located at the other side of the waveguide 140. The first light of the virtual image propagating inside the waveguide 140 may be output to a target area through the second optical element 180. The target area may be the user's eye motion box (EMB). The second optical element 180 may include an output-coupler that diffracts light propagating into the waveguide 140 and outputs the light to the outside of the waveguide 140.

In an embodiment of the disclosure, the second optical element 180 may be a diffractive element configured to emit light propagating into the waveguide 140 to the outside. The diffractive element may be implemented as at least one of a DOE, a HOE, PDLC, a metasurface, etc.

Information processing and image formation for the display portion 130 may be performed directly on a computer of the electronic device 100, or the electronic device 100 may be connected to an external electronic device such as a smart phone, tablet, computer, laptop, or any other intelligent or smart device, etc. and the information processing and image formation may be performed on the external electronic device. Signal transmission between the electronic device 100 and an external electronic device may be performed through wired communication and/or wireless communication. The electronic device 100 may receive power from at least one of a built-in power source (e.g., a rechargeable battery), an external device, and an external power source.

In an embodiment of the disclosure, the electronic device 100 may include a light source 90, a third optical element 160, and an image sensor 170.

In an embodiment of the disclosure, the light source 90 may output infrared light. The light source 90 may output infrared light toward the eyeball E of the user. The light output from the light source 90 may be reflected from the eyeball E of the user and may then be incident toward the third optical element 160.

In an embodiment of the disclosure, the light source 90 may include an infra-red (IR) light source that outputs infrared light.

In an embodiment of the disclosure, the third optical element 160 may be located on the waveguide 140. The third optical element 160 may be configured to diffract infrared light. The third optical element 160 may be configured to phase-modulate infrared light reflected from the eyeball E of the user.

In an embodiment of the disclosure, the second light (e.g., the second light L2 illustrated in FIG. 2) reflected from the user's eyeball may be incident on the third optical element 160. The second light reflected from the user's eyeball may be diffracted by the third optical element 160. The degree to which the incident light is diffracted may vary depending on the design purpose of the third optical element 160.

In an embodiment of the disclosure, the third optical element 160 may be located on a first surface S1 of the waveguide 140, the first surface facing the display portion 130, and may diffract infrared light reflected from the eyeball E of the user such that an image is formed on the image sensor 170 located on a second surface S2 of the waveguide 140. The second surface S2 may be a surface of the waveguide 140, which is opposite to the first surface S1.

In an embodiment of the disclosure, the third optical element 160 may be configured to irregularly phase-modulate infrared light reflected from the eyeball E of the user. Infrared light may be phase-modulated while passing through the third optical element 160 and transformed into a first waveform. The first waveform may be received by the image sensor 170, and the electronic device 100 may obtain a coded image based on the received first waveform. The electronic device may track the user's gaze based on the coded image.

In an embodiment of the disclosure, the third optical element 160 may be located in an area on the waveguide 140 excluding an area where the first optical element 150 and the second optical element 180 are located. The area in which the first optical element 150 and the second optical element 180 are located to guide the first light of the virtual image output from the display portion 130, to the eyeball E of the user, may be distinguished or differentiated from the area in which the third optical element 160 is located in order to diffract the infrared light reflected from the eyeball E, toward the image sensor 170, so that the areas do not overlap each other.

For example, in an embodiment, the first optical element may be located in a first area on the waveguide 140, the second optical element may be located in a second area on the waveguide 140, the third optical element may be located in a third area on the waveguide 140, and the third area may be separate from the first area and the second area. The electronic device may obtain a clear image of the user's eyes by receiving infrared light entirely through the image sensor so that the first light does not act as noise, which may be advantageous for tracking the user's gaze (e.g., a gaze of the user).

In an embodiment of the disclosure, the third optical element 160 may be a diffractive element configured to modulate incident light. The diffractive element may be implemented as at least one of a DOE, a HOE, PDLC, a metasurface, etc.

In an embodiment of the disclosure, the image sensor 170 may receive the second light modulated by the third optical element 160. The electronic device 100 may obtain user gaze information by receiving the second light modulated through the image sensor 170. The electronic device 100 may track the user's gaze.

For example, the electronic device 100 may obtain a coded image by receiving the second light modulated through the image sensor 170. The electronic device 100 may input the coded image into an artificial intelligence model to obtain feature points or restore the coded image. The artificial intelligence model may be a model trained to obtain feature points or restore an image based on a coded image that is phase-modulated by a predetermined pattern.

A feature point may include information about at least one of location coordinates and a shape of an object. For example, the feature point may include at least one of a pupil feature point and a glint feature point.

Light may be received by the image sensor 170. For example, the image sensor 170 may be a two-dimensional sensor assembled in an array form including a plurality of pixels arranged in a matrix, and each of the plurality of pixels may include at least one photoelectric conversion element. The image sensor 170 may detect light using a photoelectric conversion element and output an image signal, which may be an electrical signal according to or corresponding to the detected light. The electronic device 100 may obtain an image by converting light received through the image sensor 170 into an electrical signal.

In an embodiment of the disclosure, the third optical element 160 may be located on the waveguide 140. The image sensor 170 may be located on the waveguide 140.

In an embodiment of the disclosure, the waveguide 140 may include a first surface S1 and a second surface S2 on which the second light L2 reflected from the eyeball E of the user is incident. The second surface S2 may be a surface opposite to the first surface S1. The third optical element 160 may be disposed on the first surface S1, and the image sensor 170 may be disposed on the second surface S2. The third optical element 160 and the image sensor 170 may be sequentially arranged according to or based on a direction in which infrared light travels after being output from the light source 90.

Below, an example of the operation of the electronic device 100 of the present embodiment of the disclosure is described with reference to FIG. 2.

FIG. 2 is a diagram illustrating operation of an electronic device according to an embodiment of the disclosure. In particular, FIG. 2 is a diagram for describing the operation of an electronic device by enlarging some components of FIG. 1.

For convenience of description, details that overlap with those described with reference to FIG. 1 may be simplified or omitted.

Referring to FIG. 2, the display portion 130 may output the first light L1 including a virtual image. The first light L1 output from the display portion 130 may be incident on one side of the waveguide 140. The first optical element 150 on a path of the first light L1 may diffract the first light L1 output from the display portion 130. The first light L1 output from the display portion 130 may be diffracted by the first optical element 150 and may enter the inside of the waveguide 140.

The first light L1 entering the waveguide 140 may propagate while being totally reflected inside the waveguide 140, and be diffracted by the second optical element 180 and emitted to the outside of the waveguide 140. The first light L1 emitted from the waveguide 140 may be directed to the eyeball E of the user, and the user may view a virtual image I emitted from the display portion 130.

In an embodiment, the electronic device 100 may further include a fourth optical element. The fourth optical element may be located on the waveguide 140. The fourth optical element may be configured to expand external light propagating within the waveguide 140. The fourth optical element may include a folding element that redirects input light toward the second optical element 180, or an expanding element that expands the input light.

The first light L1 may propagate while being totally reflected inside the waveguide 140, and may be diffracted and expanded by the fourth optical element. The first light L1 may be diffracted by the fourth optical element and expanded in a second direction y, or may be expanded in a first direction x and the second direction y. However, the function of the fourth optical element may be shared by the second optical element 180, and embodiments are not limited thereto. For example, the first light L1 may be diffracted by the fourth optical element and expanded in the second direction y, and then diffracted by the second optical element 180 and expanded in the first direction x to be emitted outside the waveguide 140.

The fourth optical element may be located between the first optical element 150 and the second optical element 180, arranged to overlap the second optical element 180 in some area, or may overlap second optical element 180 and be located in the same area as the second optical element 180.

In an embodiment of the disclosure, the electronic device 100 may include the light source 90. The light source may output second light L2, which may be used to track the user's gaze. In this case, an eye gaze tracking sensor may use an IR light source.

In order to track a gaze, the second light L2 in the infrared band output from the IR light source may be reflected by the eyeball E of the user and may pass through the third optical element 160. The second light L2 in the infrared band may be diffracted by the third optical element 160 to form an image on an imaging surface of the image sensor 170, or may be transformed into an irregularly phase-modulated first waveform.

The second light L2 reflected from the eyeball E and transmitted through the third optical element 160 may be received by the image sensor 170. For example, the second light L2 passing through the third optical element 160 may form an image on the imaging surface of the image sensor 170, and the electronic device 100 may obtain an image of the eyeball E of the user by receiving, through the image sensor 170, the second light L2 that has passed through the third optical element 160.

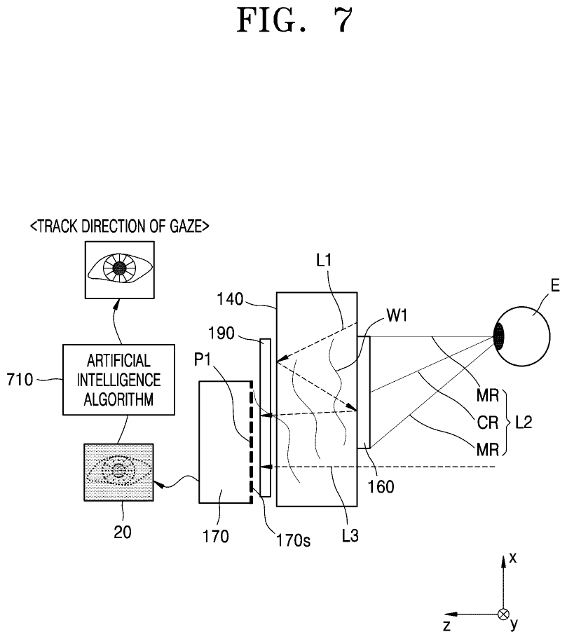

As another example, the second light L2 that has been transmitted through the third optical element 160 may be irregularly phase-modulated by the third optical element 160, thereby generating a first waveform W1 (as shown for example in FIG. 7). The first waveform W1 may be received by the image sensor 170. The electronic device 100 may obtain a coded image of the eyeball E of the user by receiving the first waveform W1 using the image sensor 170. The electronic device 100 may obtain user gaze information based on the coded image and track the user's gaze. For example, the electronic device 100 may obtain a restored image by inputting a coded image into an artificial intelligence model trained to restore the coded image, and may track the user's gaze based on the restored image.

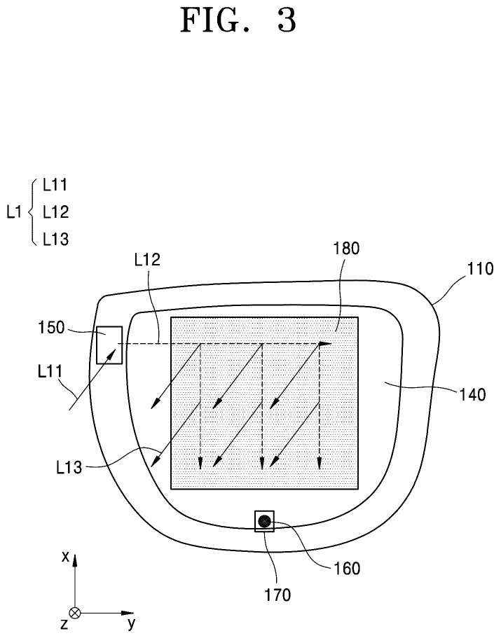

FIG. 3 is an inner side view of a portion of an electronic device for describing the arrangement of a third optical element and an image sensor, according to an embodiment of the disclosure.

In particular, FIG. 3 is an inner side view showing that a third optical element and an image sensor may be arranged in order to not overlap a first optical element and a second optical element, and for convenience of description, the description of FIG. 3 may focus on differences from the description of the details provided with reference to FIGS. 1 and 2.

Referring to FIG. 3, the electronic device according to an embodiment of the disclosure may include a frame 110, a waveguide 140, a first optical element 150, a second optical element 180, a third optical element 160, and an image sensor 170.

The waveguide 140 may be mounted on the frame 110. As shown in FIG. 3, the frame 110 may support the waveguide 140 along the circumference of the waveguide 140. Temples (e.g., the temple 120 illustrated in FIG. 1) may be respectively connected to both ends of the frame 110, and the temples may extend in a third direction z.

In an embodiment of the disclosure, a display portion (e.g., the display portion 130 illustrated in FIG. 1) may be mounted on the temples 120. The display portion 130 may output the first light L1 including a virtual image in the third direction z. The display portion 130 may output the first light L1 toward an end of the waveguide 140.

For convenience of description, the first light L1 is illustrated in FIG. 3 as first light L11 incident toward the first optical element 150, first light L12 propagating into the waveguide 140, and first light L13 emitted from the second optical element 180.

The first light L11 may be incident toward the first optical element 150. The first optical element 150 may be located on a first surface of the waveguide 140, the first surface facing the display portion 130, or on a second surface opposite the first surface, or inside the waveguide 140 (or, for example in the case of a multilayer waveguide, between multiple layers), and may allow the first light L11 output from the display portion 130, to be input to the waveguide 140.

The first light L12 entering the waveguide 140 may propagate while being totally reflected inside the waveguide 140. The first light L12 of the virtual image I propagating inside the waveguide 140 may proceed along the waveguide 140 until the first light L12 reaches the second optical element 180.

The first light L12 may be incident toward the second optical element 180. The first light L12 may be diffracted by the second optical element 180 and emitted to the outside of the waveguide 140. The second optical element 180 may be located on a first surface of the waveguide 140, the first surface facing the display portion 130, or on a second surface opposite the first surface, or inside the waveguide 140 (or, for example in the case of a multilayer waveguide, between the multiple layers), and may allow the first light L13 output from the display portion 130 to be emitted from the waveguide 140.

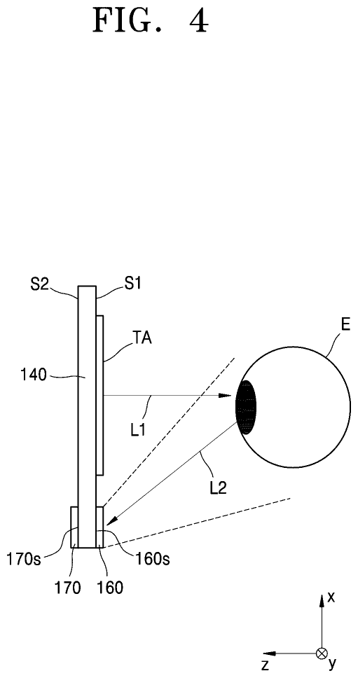

The first light L13 of the virtual image propagating inside the waveguide 140 may be output through the second optical element 180. An area to which the first light L13 is output may be a target area (e.g., the target area TA illustrated in FIG. 4). The target area TA may be the user's eye motion box (e.g., the eye motion box I illustrated in FIG. 2). The electronic device 100 may provide a virtual image to the user through the first light L13 of the virtual image emitted across the target area TA, and at the same time, the user of the electronic device 100 may view a real scene beyond the waveguide 140 formed of a transparent material.

In an embodiment of the disclosure, the third optical element 160 may be located in an area on the waveguide 140 excluding or different from the area in which the first optical element 150 and the second optical element 180 are located. For example, as illustrated in FIG. 3, the third optical element 160 may be disposed at the bottom of the waveguide 140 excluding or different from the area in which the second optical element 180 is located. However, this is only an example and embodiments are not limited thereto. For example, in an embodiment the third optical element 160 may be disposed on a side of the waveguide 140 excluding or different from the area in which the second optical element 180 is located.

In an embodiment of the disclosure, the third optical element 160 may be located in an area which excludes or is separate or different from light paths along which the first light L11, L12, and L13 travel. For example, the third optical element 160 may not be located on the path of the first light L12 that is diffracted from the first optical element 150 and propagates into the waveguide 140 toward the second optical element 180. The third optical element 160 may be disposed in an area of the waveguide 140 that does not overlap with the path of the first light L12 propagating into the waveguide 140.

In an embodiment of the disclosure, the third optical element 160 and the image sensor 170 may be sequentially arranged according to the direction in which infrared light output from the light source 90 travels. For example, as infrared light travels from an inner surface of the waveguide 140 toward an outer surface thereof, the third optical element 160 may be disposed on the inner surface of the waveguide 140, and the image sensor 170 may be disposed on the outer surface of the waveguide 140.

In an embodiment of the disclosure, the image sensor 170 may be located in an area on the waveguide 140 excluding or different from the area in which the first optical element 150 and the second optical element 180 are located.

FIG. 4 is a side view of an electronic device according to an embodiment of the disclosure.

For convenience of description, details that overlap with those described with reference to FIGS. 1 to 3 may be simplified or omitted, and the description may focus on the arrangement of some components of the electronic device.

Referring to FIG. 4, the electronic device 100 may include the waveguide 140, the third optical element 160, and the image sensor 170.

In an embodiment of the disclosure, the third optical element 160 and the image sensor 170 may be disposed on the waveguide 140. The third optical element 160 and the image sensor 170 may be sequentially arranged according to a direction of travel of second light incident on the third optical element 160. The second light L2 incident on the third optical element 160 may be light output from the light source 90 and may refer to light reflected from the eyeball E of the user.

The second light L2 incident on the third optical element 160 may be light in the infrared band output from the light source (e.g., the light source 90 illustrated in FIG. 2). The light source may output the second light L2 in the infrared band toward the eyeball E of the user, and after being output, the second light L2 may be reflected from the eyeball E of the user and may enter the third optical element 160. The output second light L2 may be diffracted by the third optical element 160 and then incident on the image sensor 170.

In an embodiment of the disclosure, the electronic device 100 may track the user's gaze by receiving the second light L2 diffracted by the third optical element 160 through the image sensor 170. For example, the electronic device 100 may obtain an image of the user's eyeball based on the second light L2 diffracted by the third optical element 160, or may obtain a feature point of the user's eyeball and then determine user gaze information, or may obtain a coded image of the eyeball of the user and then restore the coded image to track a gaze of the user.

In an embodiment of the disclosure, the waveguide 140 may include a first surface S1 and a second surface S2. The first surface S1 may be a surface on which the second light L2 is incident. The second surface S2 may be a surface opposite to the first surface S1. The third optical element 160 may be disposed on the first surface S1. The image sensor 170 may be disposed on the second surface S2. The second light L2 incident toward the third optical element 160 may sequentially pass through the third optical element 160 and the waveguide 140 and then be received by the image sensor 170. The second light L2, which may be diffracted as it passes through the third optical element 160, may be received by the image sensor 170.

In an embodiment of the disclosure, an element surface 160s of the third optical element 160 and a sensor surface 170s of the image sensor 170 may be parallel to each other. As illustrated in FIG. 3, the element surface 160s of the third optical element 160 and the sensor surface 170s of the image sensor 170 may be parallel to the x-y plane.

According to embodiments, the element surface 160s of the third optical element 160 may refer to a plane on which a nanostructure of the third optical element 160 is disposed. the third optical element 160 may be installed on the first surface S1 of the waveguide 140. For example, the third optical element 160 may be installed on the x-y plane, and the element surface 160s of the third optical element 160 may be a plane parallel to the x-y plane.

According to embodiments, the sensor surface 170s of the image sensor 170 may refer to an imaging surface on which an image of incident light is formed. As illustrated in FIG. 3, the image sensor 170 may include an imaging surface configured along the x-y plane to receive light incident in the third direction z or a diagonal direction in which the third direction and the first direction or the second direction are partially combined. The sensor surface 170s of the image sensor 170 may be a surface parallel to the x-y plane.

However, for convenience of description, examples are described herein based on the x-y plane, and the element surface 160s and the sensor surface 170s may also be inclined based on the x-y plane. However, these are only examples, and are not intended to limit the disclosure.

In an embodiment of the disclosure, the target area TA may be an area of the waveguide 140 where the first light L1 is exposed to the outside of the waveguide 140 through the second optical element 180. The electronic device 100 may provide an image to the user through the first light L1 emitted within the target area TA. The electronic device 100 may provide a virtual image to the user over the target area TA, and the wearer of the electronic device 100 may also view a real scene through the waveguide 140 formed of a transparent material.

In an embodiment of the disclosure, the third optical element 160 and the image sensor 170 may be arranged in order to not overlap the target area TA. The third optical element 160 and the image sensor 170 may be arranged such that the first light L1 does not overlap the target area TA exposed to the eyeball E of the user, so that the electronic device 100 may provide a clear image without visual interference by physical components.

An example of the shape of the third optical element 160 and the image sensor 170 arranged such that the first light L1 does not overlap the target area TA exposed to the eyeball E of the user is described above with reference to FIG. 3.

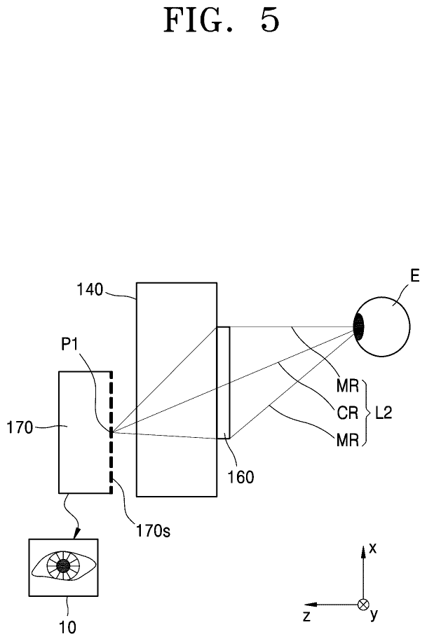

FIG. 5 is a conceptual diagram illustrating an operation of tracking a user's gaze, according to an embodiment of the disclosure.

For convenience of description, details that overlap with those described with reference to FIG. 4 may be simplified or omitted.

Referring to FIG. 5, the second light L2 output from the light source may be reflected from the eyeball E of the user and may enter the third optical element 160. For convenience of description, the second light L2 reflected from the eyeball E of the user in FIGS. 5 to 7 is described as light including a chief ray CR and at least one marginal ray MR.

In an embodiment of the disclosure, the third optical element 160 may be configured to diffract incident light so that an image is formed on the imaging surface of the image sensor 170. The chief ray CR may pass through a center of the third optical element 160, may be diffracted by the third optical element 160, and may be detected by a photoelectric conversion element located at a first position P1 of the imaging surface of the image sensor 170. The marginal ray MR may pass through one end of the third optical element 160, may be diffracted by the third optical element 160, and may be detected by the photoelectric conversion element located at the first position P1 of the imaging surface of the image sensor 170. The chief ray CR and the marginal ray MR may form an image at the first position P1 of the imaging surface of the image sensor 170. The third optical element 160 may perform a kind of lens function and may diffract the incident second light L2 so that an image is formed at the first position P1 of the imaging surface of the image sensor 170.

In an embodiment of the disclosure, the image sensor 170 may receive the second light L2 reflected from the eyeball E of the user. The image sensor 170 may detect light using the photoelectric conversion element located at the first position P1 and output an image signal, which may be an electrical signal according to the detected light. The electronic device 100 may obtain an image 10 by converting the second light L2 received through the image sensor 170, into an electrical signal.

The electronic device 100 may obtain the user gaze information from the image 10. The electronic device 100 may track the user's gaze from the image 10. The electronic device 100 may obtain, from the image 10, biometric information such as the user's iris information and use the obtained biometric information to authenticate the user.

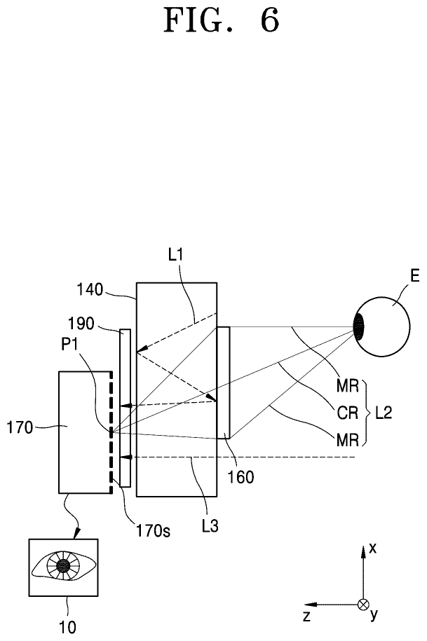

FIG. 6 is a conceptual diagram illustrating an operation of tracking a user's gaze, according to an embodiment of the disclosure.

For convenience of description, details that overlap with those described with reference to FIG. 5 may be simplified or omitted.

In an embodiment of the disclosure, light passing through the waveguide 140 and proceeding toward the image sensor 170 may further include, in addition to the second light L2 that is reflected from the eyeball E of the user and transmitted by the third optical element 160, first light L1 and third light L3 propagating into the waveguide 140.

The first light L1 may be light output from the display portion (e.g., the display portion 130 illustrated in FIG. 2) and propagated into the waveguide 140. The first light L1 may be light including a virtual image. A portion of the first light L1 may be diffracted by at least one of the first optical element 150, the second optical element 180, and the third optical element 160, and may be emitted to the outside of the waveguide 140. A portion of the emitted first light L1 may travel toward the image sensor 170.

The third light L3 may be light that may be naturally generated, excluding the first light L1 and the second light L2. For example, the third light L3 may be natural light. The third light L3 may travel toward the image sensor 170.

The image sensor 170 may obtain an image of the eyeball E of the user by receiving the second light L2. The first light L1 and the third light L3 incident toward the image sensor 170 may act as noise. When the image sensor 170 receives the first, second, and third lights L1, L2, and L3 to create an image of the eyeball E of the user, an image of lower quality may be obtained.

In an embodiment of the disclosure, the electronic device 100 may further include an optical filter 190.

In an embodiment of the disclosure, the optical filter 190 may be disposed between the third optical element 160 and the image sensor 170. For example the third optical element 160, the optical filter 190, and the image sensor 170 may be arranged sequentially according to a direction of travel of light incident on the third optical element 160.

For example, the optical filter 190 may be arranged on the waveguide 140. The optical filter 190 may be disposed between the waveguide 140 and the image sensor 170.

The optical filter 190 may filter light having a wavelength in a predetermined wavelength range. The optical filter 190 may transmit light having a wavelength in a predetermined wavelength range, and may block light having wavelengths outside the predetermined wavelength range. For example, the optical filter 190 may transmit light in the infrared band and may block light outside the infrared band. Accordingly, the image sensor 170 may receive limited light in the infrared band and may obtain an image based on the light in the infrared band.

In an embodiment of the disclosure, the optical filter 190 may filter the second light L2. The optical filter 190 may transmit the second light L2 and may block the first light L1 and the third light L3. The image sensor 170 may receive limited light from the second light L2 transmitted by the optical filter 190, and may capture an image of the eyeball E of the user based on the second light L2. Since the first light L1 and the third light L3, which act as noise, are blocked, an image of a higher quality may be captured.

FIG. 7 is a conceptual diagram illustrating an operation of tracking a user's gaze, according to an embodiment of the disclosure.

For convenience of description, details that overlap with those described with reference to FIGS. 5 and 6 may be simplified or omitted.

In an embodiment of the disclosure, the third optical element 160 may be configured to modulate the phase of the incident second light L2. A phase of the second light L2 including the chief ray CR and the marginal ray MR may be modulated by the third optical element 160. As the second light L2 passes through the third optical element 160 having a predetermined pattern, the phase-modulated second light L2 may be transformed into the first waveform W1, and the first waveform W1 may reach the imaging surface of the image sensor 170. The pattern of the third optical element 160 may be formed irregularly, and the second light L2 may be irregularly phase-modulated and transformed into the first waveform W1. As the second light L2 passes through the third optical element 160, the phase thereof may be modulated, and the first waveform W1 may proceed beyond the third optical element 160.

The first waveform W1 may be transmitted by the optical filter 190. For example, the second light L2 may be light in the infrared band, and the first waveform W1 that is phase-modulated from the second light L2 may also be light in the infrared band. The first waveform W1 may be transmitted by the optical filter 190. The first waveform W1 may be sensed by a photoelectric conversion element located on the imaging surface of the image sensor 170.

In an embodiment of the disclosure, the image sensor 170 may receive the first waveform W1 that is irregularly phase-modulated by the third optical element 160. The image sensor 170 may detect light using a photoelectric conversion element and output an image signal, which may be an electrical signal according to the detected light. The electronic device 100 may obtain a coded image 20 by converting the first waveform W1 received through the image sensor 170 into an electrical signal.

The coded image 20 may vary depending on at least one of an object (e.g., the eyeball E) from which light is reflected, the array shape of the nanostructure included in the third optical element 160, or the optical properties of light diffracted by the third optical element 160. In general, objects expressed in the coded image 20 phase-modulated by the third optical element 160 may be difficult to identify with the unaided human eye (e.g., the naked eye).

In an embodiment of the disclosure, the electronic device 100 may obtain user gaze information from the coded image 20 using a processor. The electronic device 100 may track a direction of the user's gaze according to the user gaze information.

In an embodiment of the disclosure, the electronic device 100 may obtain feature points from the coded image 20 using a processor. The processor may include or execute an artificial intelligence algorithm 710, or for example an artificial intelligence network, for acquiring feature points. The artificial intelligence algorithm 710 included in the processor may be an algorithm trained to extract feature points from a modulated image, for example the coded image 20. The electronic device 100 may track the direction of the user's gaze based on feature points extracted using the artificial intelligence algorithm 710.

For example, a feature point may include at least one of a pupil feature point and a glint feature point. The electronic device 100 may extract at least one of a pupil feature point and a glint feature point from the coded image 20. The electronic device 100 may track the direction of the user's gaze based on at least one of the pupil feature point and the glint feature point extracted using the artificial intelligence algorithm 710.

In an embodiment of the disclosure, the electronic device 100 may restore an image from the coded image 20 using a processor. For example, the artificial intelligence algorithm 710 or artificial intelligence network may be used to restore an image. The artificial intelligence algorithm 710 included in or executed by the processor may be an algorithm trained to restore an image from a modulated image, for example the coded image 20. The electronic device 100 may track the direction of the user's gaze based on the image restored using an artificial intelligence algorithm. The electronic device 100 may obtain the user's biometric information based on the image restored using an artificial intelligence algorithm and perform user authentication.

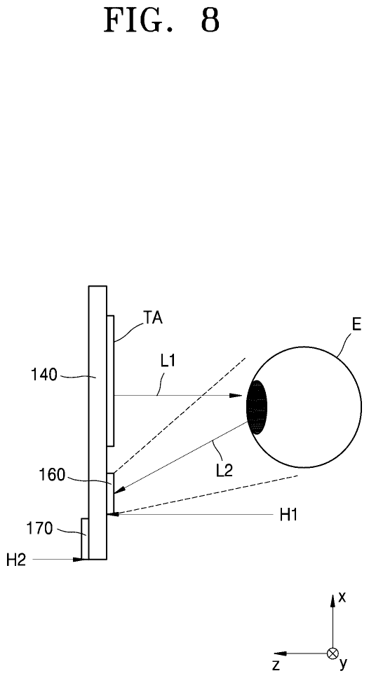

FIG. 8 is a side view of an electronic device for describing the arrangement of an optical element and an image sensor, according to an embodiment of the disclosure.

For convenience of description, the description of FIG. 8 may focus on differences from those described using FIG. 4.

Referring to FIG. 8, the third optical element 160 and the image sensor 170 may be arranged on the waveguide 140, but at different heights.

In an embodiment of the disclosure, the third optical element 160 may be disposed at a first height H1 on the waveguide 140. The image sensor 170 may be disposed at a second height H2 on the waveguide 140. The first height H1 and the second height H2 may be at different positions.

According to embodiments, the first height H1 and the second height H2 may refer to heights which are set or determined based on the first direction x. For example, the first direction x may refer to a direction perpendicular to the ground when the user wears the electronic device 100, for example a vertical direction.

In an embodiment of the disclosure, the third optical element 160 and the image sensor 170 may be arranged at different heights. Because the third optical element 160 and the image sensor 170 may be disposed at different heights, when viewed from the third direction z perpendicular to the first direction x, the third optical element 160 and the image sensor 170 may not overlap each other. When viewed in the third direction z, some areas of the third optical element 160 and the image sensor 170 may overlap each other.

In an embodiment, the third optical element 160 and the image sensor 170 may be disposed at different positions with respect to the second direction y. For example the third optical element 160 and the image sensor 170 may be arranged to be offset from each other in a horizontal direction. However, embodiments are not limited thereto.

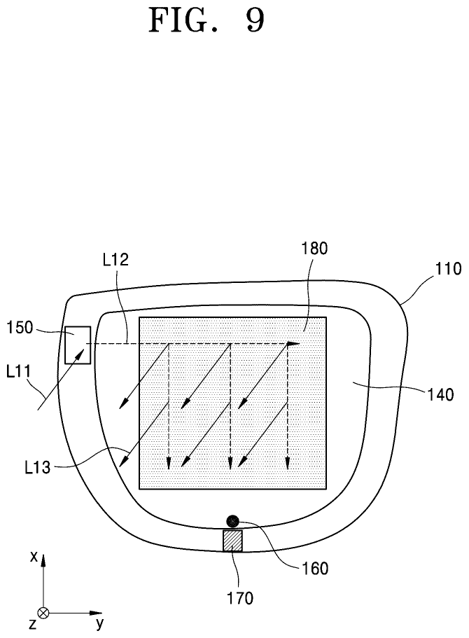

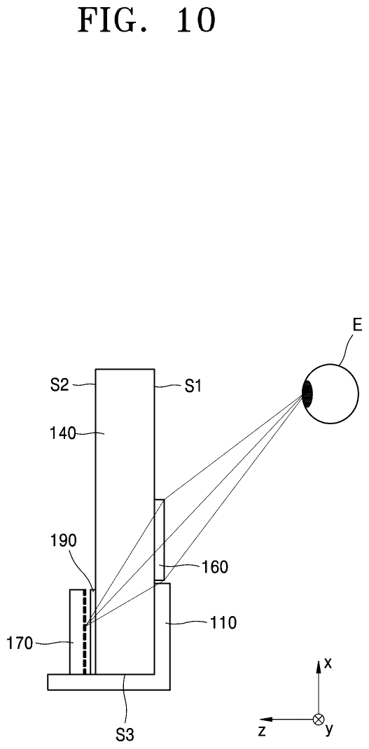

FIG. 9 is an inner side view of a portion of an electronic device for describing the arrangement of an optical element and an image sensor, according to an embodiment of the disclosure. FIG. 10 is a side view of an electronic device for describing the arrangement of an optical element and an image sensor, according to an embodiment of the disclosure. An example of a structure of an electronic device according to an embodiment of the disclosure may be described with reference to FIGS. 9 and 10.

For convenience of description, details that overlap with those described with reference to FIGS. 1 to 3 may be simplified or omitted.

In an embodiment of the disclosure, the third optical element 160 may be located in an area on the waveguide 140 excluding or different from the area in which the first optical element 150 and the second optical element 180 are located.

In an embodiment of the disclosure, the third optical element 160 and the image sensor 170 may be disposed on a lower central portion of the waveguide 140. The image sensor 170 may be arranged on the waveguide 140 such that it is covered by the frame 110. An example of this is described below with reference to FIG. 10, which is an enlarged view and a side view of some components according to an embodiment.

FIG. 10 is a side view of an electronic device for describing the arrangement of an optical element and an image sensor, according to an embodiment of the disclosure.

For convenience of description, the description may focus on differences from the description with reference to FIGS. 4 and 8.

Referring to FIG. 10, in an embodiment of the disclosure, the frame 110 may surround a third surface S3 and a portion of the first surface S1 of the waveguide 140. The third surface S3 may refer to a lower surface of the waveguide 140. The first surface S1 may refer to a front surface of the waveguide 140, on which infrared light reflected from the eyeball E of the user may be incident. The frame 110 may surround the third surface S3, which may be a lower surface of the waveguide 140, and a portion of the first surface S1, which may be the front surface of the waveguide 140, and may support the waveguide 140.

In an embodiment of the disclosure, the third optical element 160 may be disposed on the first surface S1. The image sensor 170 may be disposed on the second surface S2. The second surface S2 may refer to a rear surface of the waveguide 140 opposite to the first surface S1. The third optical element 160 and the image sensor 170 may be sequentially arranged according to a direction of travel of light incident on the third optical element 160.

In an embodiment of the disclosure, the third optical element 160 may be disposed at a first height on the waveguide 140. The image sensor 170 may be disposed at a second height on the waveguide 140. The first height may be different from the second height. The third optical element 160 and the image sensor 170 are each disposed on the waveguide 140, and may be disposed at different heights with respect to the first direction x.

In an embodiment of the disclosure, the image sensor 170 may be disposed on a portion of the second surface S2 of the waveguide 140, which may correspond to a portion of the first surface S1 of the waveguide 140 surrounded by the frame 110. When viewed from a viewpoint in the third direction z, the image sensor 170 may be covered by the frame 110 surrounding or around a portion of the first surface S1 of the waveguide 140.

The third optical element 160 may be disposed on the frame 110 surrounding or around a portion of the first surface S1 of the waveguide 140.

By arranging the image sensor 170 such that the image sensor 170 is covered by the frame 110, the electronic device 100 according to an embodiment of the disclosure may provide a more natural real-world scene.

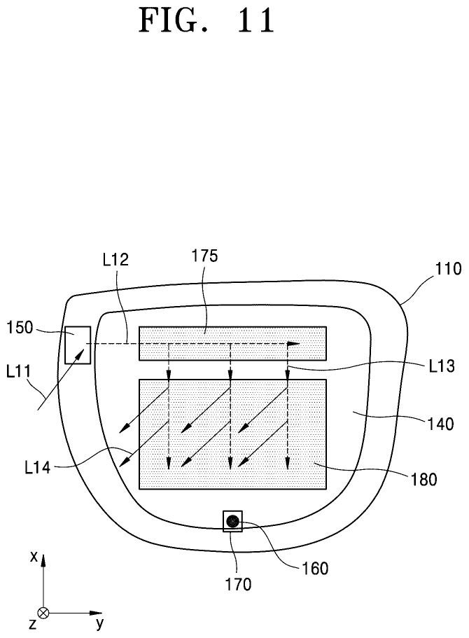

FIG. 11 is an inner side view of a portion of an electronic device for describing the arrangement of a third optical element and an image sensor, according to an embodiment of the disclosure.

For convenience of description, the description of FIG. 11 may focus on differences from those described using FIGS. 3 and 9.

Referring to FIG. 11, in an embodiment of the disclosure, the electronic device 100 may further include a fourth optical element 175.

The fourth optical element 175 may be located on the waveguide 140. The fourth optical element 175 may be configured to expand the first light L1 propagating within the waveguide 140. Additionally, the fourth optical element 175 may be configured to allow the input first light L1 to proceed toward the second optical element 180. The fourth optical element 175 may include a folding element that may redirect input light toward the second optical element 180 or an expanding element that may expand input light.

In an embodiment of the disclosure, the fourth optical element 175 may be a diffractive element configured to change a traveling direction of light or expand input light. The diffractive element may be implemented as at least one of a DOE, a HOE, PDLC, a metasurface, etc.

The first light L1 may propagate while being totally reflected inside the waveguide 140, and may be diffracted and expanded by the fourth optical element 175. The first light L1 may be diffracted in the fourth optical element 175 and expanded in the second direction y, or may be expanded in the first direction x and the second direction y. However, the function of the fourth optical element 175 may be shared by the second optical element 180, and embodiments are not limited thereto. For example, the first light L1 may be diffracted by the fourth optical element 175 and expanded in the second direction y, and diffracted by the second optical element 180 and expanded in the first direction x to be emitted outside the waveguide.

Although FIG. 11 illustrates an example in which the fourth optical element 175 and the second optical element 180 are arranged as separate components, embodiments are not limited thereto, and in an embodiment the fourth optical element 175 and the second optical element 180 may be formed as a single body. For example, the first light L1 may be incident into the inside of the waveguide 140 by the first optical element 150, expanded by the second optical element 180, and emitted to the outside of the waveguide 140. Embodiments are not limited thereto.

For convenience of description, with reference to FIG. 11, the first light L1 is illustrated as the first light L11 incident toward the first optical element 150, the first light L12 propagating into the waveguide 140, the first light L13, which expands inside the waveguide 140 and has a changed traveling direction, and the first light L14 emitted from the second optical element 180.

The first light L11 may be incident toward the first optical element 150. The first optical element 150 may be located on a first surface of the waveguide 140, the first surface facing the display portion 130, or on a second surface opposite the first surface, or inside the waveguide 140 (or, for example in the case of a multilayer waveguide, between the multiple layers), and allow the first light L11 output from the display portion 130, to be input to the waveguide 140.

The first light L12 entering the waveguide 140 may propagate while being totally reflected inside the waveguide 140. The first light L12 of the virtual image I propagating inside the waveguide 140 may proceed along the waveguide 140 until the first light L12 reaches the fourth optical element 175.

The first light L12 may be incident toward the fourth optical element 175. The first light L12 may be diffracted by the fourth optical element 175 and expanded in the second direction y, or the traveling direction of the first light L12 may be changed toward the second optical element 180. As another example, the first light L12 may be diffracted by the fourth optical element 175 and expanded in the first direction x and the second direction y, but embodiments are not limited thereto.

The first light L13 may be incident toward the second optical element 180. The first light L13 may be diffracted by the second optical element 180 and emitted to the outside of the waveguide 140. The second optical element 180 may be located on a first surface of the waveguide 140, the first surface facing the display portion 130, or on a second surface opposite the first surface, or inside the waveguide 140 (or, for example in the case of a multilayer waveguide, between the multiple layers), and allow the first light L14 output from the display portion 130, to be emitted from the waveguide 140.

The first light L14 of the virtual image propagating inside the waveguide 140 may be output through the second optical element 180. An area from which the first light L14 is output may be a target area (e.g., the target area TA illustrated in FIG. 4). The target area TA may be the user's eye motion box (e.g., the eye motion box I illustrated in FIG. 2). The electronic device 100 may provide a virtual image to the user through the first light L14 of the virtual image emitted across the target area TA, and at the same time, the user of the electronic device 100 may view a real scene beyond the waveguide 140 formed of a transparent material.

In an embodiment of the disclosure, the third optical element 160 may be located in an area which excludes or is separate or different from the area in which the first optical element 150, the second optical element 180, and the fourth optical element 175 are located.

In an embodiment of the disclosure, the third optical element 160 may be located in an area which excludes or is separate or different from light paths along which the first light L11, L12, L13, and L14 travel. For example, the third optical element 160 may not be located on the path of the first light L12 that is diffracted from the first optical element 150 and propagates into the waveguide 140 toward the fourth optical element 175. The third optical element 160 may be disposed in an area of the waveguide 140 that does not overlap with the path of the first light L12 propagating into the waveguide 140.

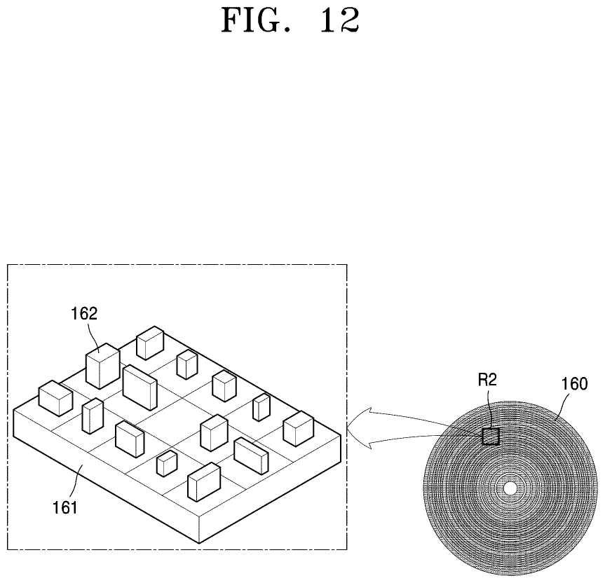

FIG. 12 is a conceptual diagram for describing an optical element according to an embodiment of the disclosure.

Referring to FIG. 12, in an embodiment of the disclosure, the electronic device 100 may modulate the phase of incident light using the third optical element 160. The third optical element 160 may be a diffractive element that modulates the phase of incident light. The diffractive element may be implemented as at least one of a DOE, a HOE, PDLC, a metasurface, etc.

The third optical element 160 may have, for example, a circular pattern. The third optical element 160 may have a pattern in which a certain shape is regularly repeated. For example the third optical element 160 may have a concentric circle pattern in which circular patterns with radii of different sizes are repeated.

However, the shape of the pattern of the optical element illustrated in FIG. 10 is only an example, and embodiments are not limited thereto. For example, the optical element may have a square pattern. The optical element may have a pattern in which a rectangular shape is repeated. As another example, the optical element has a generally circular pattern but may also include some irregular patterns.

For convenience of description, an example of the third optical element 160 is described by enlarging a second region R2 of the optical element. In an embodiment of the disclosure, the third optical element 160 may include a substrate 161 and a plurality of nanostructures 162.

The substrate 161 may have a flat shape. A plurality of nanostructures 162 may be disposed on the substrate 161. The plurality of nanostructures 162 may extend perpendicular to an upper surface of the substrate 161. As illustrated in FIG. 12, the plurality of nanostructures 162 may include pillars in the shape of a rectangular parallelepiped. The plurality of nanostructures 162 may be arranged apart from each other at a predetermined interval.

The constituent material of the plurality of nanostructures 162 may include a dielectric material with a high refractive index to increase the possibility of complex amplitude control by maximizing interaction with incident light. For example, the plurality of nanostructures 162 may include a-Si, a-Si:H, TiO₂, GaN, etc.

In FIG. 12, the height of the plurality of nanostructures 162 is shown to be irregularly formed, but embodiments are not limited thereto. For example, the plurality of nanostructures 162 may be arranged in a form in which a first height and a second height are regularly repeated.

In an embodiment of the disclosure, the plurality of nanostructures 162 included in the third optical element 160 may guide incident light toward the third optical element 160 to an arbitrary focus according to heights and patterns of the nanostructures 162. According to embodiments, the heights and patterns may refer to a height difference between the plurality of nanostructures 162 and the pattern shape thereof on the third optical element 160 due to the height difference. For example, the third optical element 160 may perform the function of a lens.

In an embodiment of the disclosure, the plurality of nanostructures 162 included in the third optical element 160 may modulate the phase of incident light incident on the third optical element 160 according to their height and pattern, and generate an irregularly modified first waveform. The electronic device 100 may obtain a coded image by receiving the first waveform through an image sensor. The electronic device 100 may track the user's gaze from the coded image.

The plurality of nanostructures 162 included in the third optical element 160 may guide incident light incident on an optical system to a random focus depending on the array shape thereof, or modulate the phase of the incident light to form an irregularly modified first waveform. Here, “array shape” refers to at least one of the size, shape, and arrangement spacing of each nanostructure 162, size distribution by position, shape distribution by position, or spacing distribution by position of the nanostructures 162 with respect to an area where a meta-lens is located. The detailed array shape of the nanostructures 162 included in the third optical element 160 may vary depending on the optical performance required for the third optical element 160. For example, the array shape of the nanostructures 162 may vary depending on the wavelength band and focal length of light to be focused through the third optical element 160.

In an embodiment of the disclosure, the substrate 161 may be or may include the waveguide 140. The plurality of nanostructures 162 may be installed on the waveguide 140. For example, a dielectric material may be applied on the waveguide 140. An etching process may be performed so that the applied dielectric material has a certain pattern.

In an embodiment of the disclosure, the third optical element 160 including the substrate 161 and the plurality of nanostructures 162 may be disposed on the waveguide 140. The substrate 161 may be separate from the waveguide 140 and may be disposed on the waveguide 140.

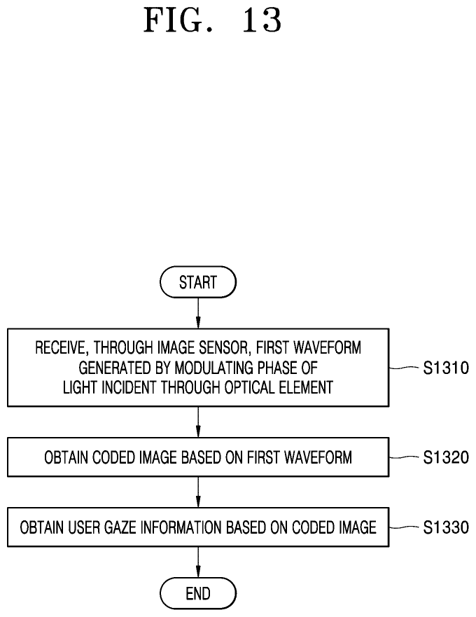

FIG. 13 is a flowchart of an operating method of an electronic device, according to an embodiment of the disclosure.

Referring to FIG. 13, at operation S1310, the electronic device may receive, using an image sensor, a first waveform generated by modulating the phase of light incident through an optical element. At operation S1320, the electronic device may obtain a coded image based on the first waveform.

In an embodiment of the disclosure, the electronic device may use an image sensor to receive the first waveform transmitted by the optical element. The first waveform may be a waveform of light irregularly phase-modulated from light incident toward the optical element. The electronic device may obtain a coded image by receiving light from the first waveform. The electronic device may obtain a coded image corresponding to an object based on a distribution of the first waveform transmitted by the optical element.

The coded image may vary depending on at least one of an object from which light is reflected (e.g., an eyeball) or an array shape of nanostructures included in the optical element. Depending on the array shape of the irregular nanostructures of the optical element, the coded image obtained by receiving the first waveform transmitted by the optical element may be difficult to identify with the naked eye.

At operation S1330, the electronic device may obtain user gaze information from or based on the coded image.

In an embodiment of the disclosure, the electronic device may obtain a feature point by inputting a coded image into an artificial intelligence model that is trained to extract the feature point from the coded image. The electronic device may obtain user gaze information based on the extracted feature point. The electronic device may track a gaze of the user based on the extracted feature point.

In an embodiment of the disclosure, the electronic device may obtain a restored image by inputting the coded image into an artificial intelligence model trained to restore an original image from or based on the coded image. The electronic device may obtain user gaze information based on the restored image. The electronic device may track the user's gaze based on the coded image.

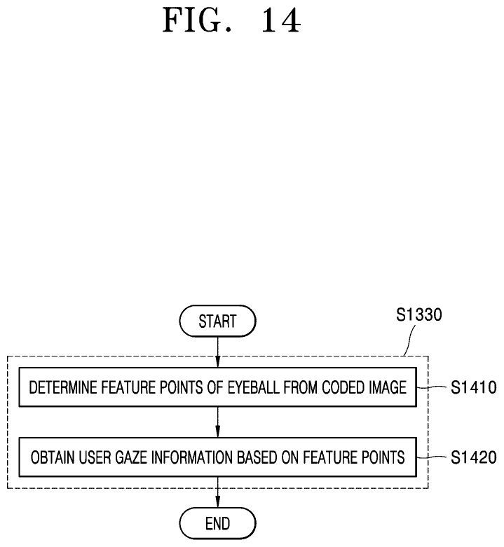

FIG. 14 is a flowchart illustrating an operating method of an electronic device, according to an embodiment of the disclosure.

Referring to FIG. 14, operation S1330 of FIG. 13 may include operations S1410 and S1420.

At operation S1410, the electronic device may determine one or more feature points corresponding to the eyeball from the coded image.

According to embodiments, a feature point may refer to a point representing a major feature or a point of interest in an image. For example, the feature point may be a corner at which two or more edges detected based on a change in pixel value intersect each other, a point at which the pixel value is maximum or minimum within the image, etc.

For example, a feature point about the eyeball may include at least one of a pupil feature point and a glint feature point. The electronic device may extract at least one of a pupil feature point and a glint feature point from the coded image.

In an embodiment of the disclosure, the electronic device may obtain a feature point by inputting a coded image into an artificial intelligence model that is trained to extract the feature point from the coded image.

At operation S1420, the electronic device may obtain user gaze information based on the feature point.

In an embodiment of the disclosure, the electronic device may track a direction of the user's gaze based on at least one of a pupil feature point and a glint feature point extracted using an artificial intelligence algorithm.

In an embodiment of the disclosure, the electronic device may extract a feature point from the coded image. The electronic device may include an artificial intelligence algorithm or an artificial intelligence network for extracting feature points. An artificial intelligence algorithm may be an algorithm trained to extract feature points from a modulated image, for example a coded image. The electronic device may track a direction of the user's gaze based on feature points extracted using an artificial intelligence algorithm.

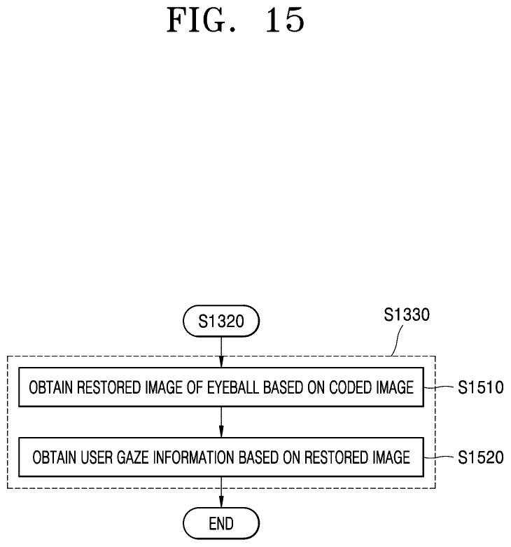

FIG. 15 is a flowchart illustrating an operating method of an electronic device, according to an embodiment of the disclosure.

Referring to FIG. 15, operation S1330 of FIG. 13 may include operations S1510 and S1520.

At operation S1510, the electronic device may obtain a restored image of the eyeball from or based on the coded image.

In an embodiment of the disclosure, the electronic device may obtain a restored image by inputting the coded image into an artificial intelligence model trained to restore an original image from the coded image.

At operation S1520, the electronic device may obtain user gaze information based on the restored image.

In an embodiment of the disclosure, the electronic device may track a direction of the user's gaze based on the restored image obtained using an artificial intelligence algorithm.

In an embodiment of the disclosure, the electronic device may obtain the restored image from the coded image. The electronic device may include an artificial intelligence algorithm or an artificial intelligence network for obtaining a restored image. The artificial intelligence algorithm may be an algorithm trained to obtain a restored image from a modulated image, for example a coded image. The electronic device may track the direction of the user's gaze based on the restored image obtained using an artificial intelligence algorithm.

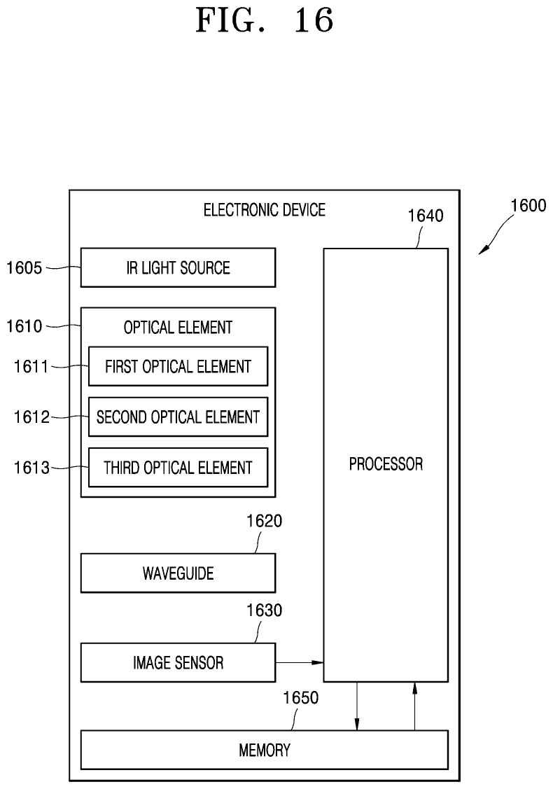

FIG. 16 is a block diagram illustrating components of an electronic device, according to an embodiment of the disclosure.

For convenience of description, details that overlap with those described with reference to FIGS. 1 to 3 may be simplified or omitted.

An electronic device 1600 may be a device that obtains an image by receiving light transmitted through a third optical element 1613 through an image sensor 1630. The electronic device 1600 may be implemented as, for example, a mobile device, a smart phone, a laptop computer, a desktop, a tablet personal computer (PC), a wearable device, an e-reader, a digital broadcasting terminal, and a personal digital assistant (PDA), a portable multimedia player (PMP), a navigation device, an MPEG Audio Layer-3 (MP3) player, a camcorder, or other various devices. In an embodiment of the disclosure, the electronic device 1600 may be an augmented reality device. Augmented reality devices are devices that may express “augmented reality”, and may include glasses-shaped augmented reality glasses that users wear on the face, as well as a head mounted display (HMD) apparatus or an augmented reality helmet worn on the head.

Referring to FIG. 16, the electronic device 1600 may include an optical element 1610, a waveguide 1620, an image sensor 1630, a processor 1640, and a memory 1650. The image sensor 1630, the processor 1640, and the memory 1650 may each be electrically and/or physically connected to each other.

The components illustrated in FIG. 16 are merely an example, and the components included in the electronic device 1600 are not limited to those illustrated in FIG. 16. The electronic device 1600 may not include some of the components illustrated in FIG. 16 and may further include components not illustrated in FIG. 16. For example, the electronic device 1600 may further include a power supply unit (e.g., a battery) that supplies driving power to the optical element 1610, the processor 1640, and the memory 1650.

In an embodiment of the disclosure, the image sensor 1630 of the disclosure may be used to track a gaze. In this case, the image sensor 1630 typically uses an IR light source 1605. In order to track a gaze using the image sensor 1630, light in the infrared band output from the IR light source 1605 may be reflected from the eyeball and pass through the optical element 1610. Light reflected from the eyeball and transmitted through the optical element 1610 may be received by the image sensor 1630.

In an embodiment of the disclosure, the optical element 1610 may include a first optical element 1611, a second optical element 1612, and a third optical element 1613.

The first optical element 1611 may be a diffractive element that propagates external light into the waveguide 1620. The second optical element 1612 may be a diffractive element that outputs external light propagated inside the waveguide 1620 by the first optical element 1611, to the outside of the waveguide 1620.

For example, external light including a virtual image output from a display portion may be incident toward the waveguide 1620. The incident external light may be diffracted by the first optical element 1611 and be totally reflected inside the waveguide 1620 and propagated. The propagated external light may be diffracted by the second optical element 1612 and output outside the waveguide 1620. External light including a virtual image may reach the eyes of a user as a path of the external light is guided by the first optical element 1611 and the second optical element 1612. The user wearing the electronic device 1600 according to an embodiment of the disclosure may perceive guided external light and view a virtual image. At the same time, the waveguide 1620 may include a transparent material, so the user may view a real scene beyond the waveguide 1620 along with the virtual image.

The third optical element 1613 may be a diffractive element configured to diffract infrared light output from the IR light source 1605. The third optical element 1613 may be configured to phase-modulate infrared light reflected from the eyeball E of the user.

The third optical element 1613 may include a substrate and a plurality of nanostructures extending perpendicular to the top surface of the substrate. The third optical element 1613 may include a separate substrate. For example, the third optical element 1613 may be arranged on the waveguide 1620, for example a substrate may be arranged on the waveguide 1620, and a plurality of nanostructures may be arranged on the substrate.

In an embodiment of the disclosure, the third optical element 1613 may include a plurality of nanostructures disposed in an area which excludes or is separate or different from the area where the first optical element 1611 and the second optical element 1612 are located on the waveguide 1620. For example, the third optical element 1613 may be arranged on the waveguide 1620, for example a plurality of nanostructures may be arranged in contact with the waveguide 1620.

In an embodiment of the disclosure, the third optical element 1613 may be or may include a lens in which relatively small-scale nanostructures are arranged in two dimensions. The third optical element 1613 may include a surface including nanostructures arranged on a substrate, and the phase of transmitted light may be modulated depending on the arrangement and shape of the nanostructures of the third optical element 1613.

In an embodiment of the disclosure, the third optical element 1613 may be configured to modulate incident light. The third optical element 1613 may be located on the waveguide 1620. Light incident on the third optical element 1613 may be light reflected from the user's eyeball.

In an embodiment of the disclosure, the third optical element 1613 may modulate the phase of incident light so that the incident light forms an image within an imaging surface of the image sensor 1630. For example, the third optical element 1613 may perform the function of a lens.

In an embodiment of the disclosure, the third optical element 1613 may generate a first waveform from or based on incident light by irregularly modulating the phase of the incident light. The first waveform may be transmitted by the third optical element 1613 and then received by the image sensor 1630.

In an embodiment of the disclosure, first light of the virtual image generated in the display portion and light of an external scene to the user's pupil are transmitted through the waveguide 1620. The waveguide 140 may have a flat shape. The waveguide 1620 may be formed as a single-layer or multi-layer structure of a transparent material through which light may be internally reflected to be propagated. Here, a transparent material refers to a material through which light in the visible light band may pass, and the transparency thereof may not be 100%, and the transparent material may have a certain color. Because the waveguide 1620 may include a transparent material, the user may view a virtual image through the electronic device 1600 and also view a real scene, and thus the electronic device 1600 may implement or provide an augmented reality experience to a user. The waveguide 1620 may be provided on each of the left and right eyes corresponding to the display portion, or may be provided on only one side.

In an embodiment, the electronic device 1600 may include a waveguide image combiner configured to receive light from a virtual image and transmit the light to the user's eyes. The waveguide image combiner may refer to a component including an optical element 1610 and a waveguide 1620.

In an embodiment of the disclosure, an electronic device may be an augmented reality device including a display engine and a waveguide image combiner. The display engine may be configured to output image light. The waveguide image combiner may guide the image light output from the display engine, to a target area. The target area may be an eye motion box of a user.

In an embodiment of the disclosure, the augmented reality device may be or may include augmented reality glasses that include left-eye element and a right-eye element respectively corresponding to the user's left and right eyes. A display engine and a waveguide image combiner may be included in one or more of the left-eye element and the right-eye element.

The image sensor 1630 may be an image capturing device configured to receive light modulated by the third optical element 1613, convert brightness or intensity of the received light into an electrical signal, and image the electrical signal to thereby obtain a coded image. The image sensor 1630 may be implemented by, for example, a charge coupled device (CCD) or a complementary metal-oxide semiconductor (CMOS), but embodiments are not limited thereto. The image sensor 1630 may be arranged on the waveguide 1620.

In an embodiment of the disclosure, the third optical element 1613 and the image sensor 1630 may be disposed on the waveguide 1620. The third optical element 1613 and the image sensor 1630 may be sequentially arranged according to a direction of travel of light incident on the third optical element 160.

For example, the waveguide 1620 may be located between the third optical element 1613 and the image sensor 1630. The waveguide 1620 may include a first surface and a second surface opposite to the first surface, the third optical element 1613 may be disposed on the first surface, and the image sensor 1630 may be arranged on the second surface.

In an embodiment of the disclosure, an element surface of the third optical element 1613 and a sensor surface of the image sensor 1630 may be parallel to each other.

In an embodiment of the disclosure, the third optical element 1613 may be disposed at a first height on the waveguide 1620. The image sensor 1630 may be arranged at a second height on the waveguide 1620. The first height and the second height may be different from each other. For example the third optical element 1613 and the image sensor 1630 may be arranged on the waveguide 1620 and at different heights from each other.

In an embodiment of the disclosure, the electronic device may further include a frame surrounding or around a lower surface and a portion of a front surface of the waveguide 1620. The image sensor 1630 may be disposed on a portion of a back surface of the waveguide 1620, which may correspond to a portion of the front surface of the waveguide 1620 surrounded by the frame. The image sensor 1630 may be covered by a frame when viewed from the front surface of the waveguide 1620.

In an embodiment of the disclosure, the electronic device may provide a virtual image by outputting first light including the virtual image, from the waveguide 1620, toward the eyeballs of the user. For example, the first light may be output from the display portion installed on the temples of glasses, propagate into the waveguide 1620 by a first optical element, be diffracted by a second optical element, and be emitted out of the waveguide 1620.

The waveguide 1620 may include an image combiner area at which the first light is exposed outside the waveguide. In an embodiment of the disclosure, the optical element 1610 and the image sensor 1630 may be arranged in order to not overlap the image combiner area.

The processor 1640 may execute one or more instructions or program code stored in the memory 1650 and may perform functions and/or operations corresponding to the instructions or program code. The processor 1640 may include hardware components that perform arithmetic, logic, input/output operations, and signal processing. The processor 1640 may include, for example, at least one of a central processing unit, a microprocessor, a graphics processing unit, an application processor (AP), an application specific integrated circuit (ASIC), a digital signal processors (DSP), a digital signal processing device (DSPD), a programmable logic device (PLD), and a field programmable gate array (FPGA), but embodiments are not limited thereto.

In FIG. 16, the processor 1640 is illustrated as a single element, but embodiments are not limited thereto. In an embodiment of the disclosure, the processor 1640 may include one processor or more than one processor.

In an embodiment of the disclosure, the processor 1640 may be configured as a dedicated hardware chip that performs artificial intelligence (AI) learning.

The memory 1650 may store instructions and program code which are readable by the processor 1640. The memory 1650 may include, for example, at least one of a flash memory type, a hard disk type, a multimedia card micro type, a card type memory (e.g., SD or XD memory, etc.), random access memory (RAM), static random access memory (SRAM), read-only memory (ROM), electrically erasable programmable read-only memory (EEPROM), programmable read-only memory (PROM), mask ROM, flash ROM, a hard disk drive (HDD), and a solid state drive (SSD).

The memory 1650 may store instructions or program codes for performing functions or operations of the electronic device 1600. In an embodiment of the disclosure, the memory 1650 may store at least one of instructions, an algorithm, a data structure, program code, and an application program that may be read by the processor 1640. Instructions, algorithms, data structures, and program codes stored in the memory 1650 may be implemented in, for example, programming or scripting languages such as C, C++, Java, assembler, etc.

The memory 1650 may store instructions, algorithms, data structures, or program codes related to an artificial intelligence model for obtaining user gaze information from a coded image. For example, the memory 1650 may store program codes for obtaining feature points or restored images from a coded image and tracking the user's gaze through the feature points or restored images. A “module” included in the memory 1650 may refer to a unit that processes functions or operations performed by the processor 1640, and may be implemented as software such as instructions, algorithms, data structures, or program code.

The processor 1640 may track the user's gaze from the coded image. The processor 1640 may track the user's gaze using an artificial intelligence algorithm trained to obtain user gaze information from a coded image phase-modulated by a predetermined pattern of the optical element 1610.

In the following embodiment of the disclosure, the processor 1640 may be implemented by executing instructions or program codes stored in the memory 1650.

In an embodiment of the disclosure, the processor 1640 may obtain a coded image based on the first waveform received by the image sensor 1630. The processor 1640 may obtain user gaze information based on the coded image.

In an embodiment of the disclosure, the processor 1640 may obtain feature points related to the eyeball based on the coded image. The processor 1640 may obtain the user gaze information based on the feature point.

In an embodiment of the disclosure, the processor 1640 may obtain a restored image of the eye based on the coded image. The processor 1640 may obtain user gaze information based on the restored image.

The processor of the electronic device according to an embodiment of the disclosure may use an artificial intelligence model trained to obtain user gaze information from a coded image. In an embodiment of the disclosure, the artificial intelligence model may be a deep neural network (DNN) model trained by a supervised learning method by applying, as input data, a coded image obtained according to a distribution of light simulated based on an optical element, and applying, as ground truth, a gaze of a user corresponding to the coded image. “Training” may refer to the ability of a neural network to discover or learn on its own how to analyze input data to a neural network, how to classify input data, and/or how to extract features necessary to generate result data from input data. Through a learning process, the deep neural network model may train learning data (e.g., multiple original images and multiple feature points) to optimize weight values within the neural network. The deep neural network model outputs a desired result by processing input data through a neural network with optimized weight values.

The type of artificial intelligence model is not limited to the examples discussed above, and for example in an embodiment the artificial intelligence model may be implemented as at least one of a convolutional neural network (CNN), a recurrent neural network (RNN), a restricted Boltzmann machine (RBM), a Deep Belief Network (DBN), a Bidirectional Recurrent Deep Neural Network (BRDNN), or Deep Q-Networks. Additionally, the artificial intelligence model may be segmented. For example, the convolutional neural network model may be subdivided into a Deep Convolution Neural Network (D-CNN) and a Capsnet neural network.

The processor 1640 may obtain user gaze information from a coded image using a previously trained artificial intelligence model. In an embodiment of the disclosure, the processor 1640 may input a coded image obtained through the image sensor 1630 to an artificial intelligence model and perform inference using the artificial intelligence model, thereby obtaining user gaze information corresponding to the coded image. For example, a pre-trained artificial intelligence model may obtain a feature point or a restored image corresponding to a coded image, and may obtain user gaze information based on the feature point or the restored image.

The artificial intelligence model may be stored in the memory 1650 of the electronic device 1600. However, this is only an example and embodiments are not limited thereto. For example, the artificial intelligence model may be stored on an external server. In this case, the electronic device 1600 may further include a communication interface capable of performing data communication with an external server, and receive the artificial intelligence model or inference result data by the artificial intelligence model from the external server through the communication interface (e.g., a feature point). In general, the electronic device 1600 may have limited memory storage capacity, operation processing speed, and learning data set collection ability compared to a server. Accordingly, operations that use storage of large amounts of data and large amounts of computation may be performed on a server, and then the data and/or artificial intelligence model may be transmitted to the electronic device 1600 through a communication network. In this case, the electronic device 1600 may quickly and easily perform operations by receiving and using an artificial intelligence model or inference data based on an artificial intelligence model through a server without a processor with a large memory and fast computing ability.

An electronic device according to an embodiment of the disclosure may include an IR light source, a waveguide, a first optical element, a second optical element, a third optical element, and an image sensor. The IR light source may output infrared light. The first optical element may be located on a first area of a waveguide. The first optical element may be configured to allow external light to enter the waveguide. The second optical element may be located on a second area of the waveguide. The second optical element may be configured to output external light incident into the waveguide, to the outside of the waveguide. The third optical element may be located on the waveguide, for example in an area other than an area where the first optical element and the second optical element are located. For example, the third optical element may be located on a third area of the waveguide, and the third area may be different from the first area and the second area. The third optical element may be configured to diffract infrared light. The image sensor may receive light diffracted by the third optical element.

In an embodiment of the disclosure, the third optical element and the image sensor may be sequentially arranged according to a direction in which infrared light travels. For example, the third optical element and the image sensor may be sequentially arranged based on a direction of the infrared light.

In an embodiment of the disclosure, the third optical element may be configured to diffract infrared light so that an image is formed on an imaging surface of the image sensor.

In an embodiment of the disclosure, the third optical element may be configured to modulate the phase of infrared light so that a first waveform reaches the imaging surface of the image sensor. The electronic device may further include at least one processor. At least one processor may obtain a coded image based on the first waveform received by the image sensor. The at least one processor may obtain user gaze information based on the coded image.

In an embodiment of the disclosure, the at least one processor may obtain a feature point related to or corresponding to the eyeball based on the coded image. The at least one processor may obtain user gaze information based on the feature point.

In an embodiment of the disclosure, the at least one processor may obtain a restored image of or about the eyeball based on the coded image. The at least one processor may obtain user gaze information and biometric information based on the restored image.

In an embodiment of the disclosure, the waveguide may include a first surface on which infrared light is incident and a second surface opposite to the first surface. A third optical element may be disposed on the first surface. An image sensor may be arranged on the second surface.

In an embodiment of the disclosure, the third optical element may be disposed at a first height on the waveguide. The image sensor may be arranged on the wave guide at a second height different from the first height.

In an embodiment of the disclosure, the electronic device may further include a frame surrounding or around a lower surface and a portion of the first surface of the waveguide. The image sensor may be disposed on a portion of the second surface of the waveguide, which corresponds to a portion of the first surface of the waveguide surrounding or around the frame.

In an embodiment of the disclosure, the electronic device may further include a fourth optical element. The first optical element may be located on the waveguide. The fourth optical element may be configured to expand external light propagating within the waveguide. The third optical element may be located in an area which excludes or is separate or different from the area where the fourth optical element is located.

In an embodiment of the disclosure, the third optical element may include a substrate and a plurality of nanostructures extending perpendicular to an upper surface of the substrate.

In an embodiment of the disclosure, the first optical element, the second optical element, the third optical element, and the fourth optical element may each include a plurality of nanostructures disposed on the waveguide.

In an embodiment of the disclosure, the electronic device may further include an optical filter configured to filter light according to a wavelength range. The third optical element, the optical filter, and the image sensor may be sequentially arranged according to a direction in which infrared light travels. For example, the third optical element, the optical filter, and the image sensor may be sequentially arranged based on a direction of the infrared light.

A waveguide image combiner according to an embodiment of the disclosure may include a waveguide, a first optical element, a second optical element, and a third optical element. The first optical element may be located on a first area of the waveguide. The first optical element may be configured to allow external light to enter the waveguide. The second optical element may be located on a second area of the waveguide. The second optical element may be configured to output external light incident into the waveguide, to the outside of the waveguide. The third optical element may be located on the waveguide in an area other than an area where the first optical element and the second optical element are located. For example, the third optical element may be located on a third area of the waveguide, and the third area may be different from the first area and the second area. The third optical element may be configured to diffract infrared light output from the light source.

In an embodiment of the disclosure, the waveguide image combiner may further include a fourth optical element. The first optical element may be located on the waveguide. The fourth optical element may be configured to expand external light propagating within the waveguide. The third optical element may be located in an area which excludes or is separate or different from a fourth area where the fourth optical element is located.

An augmented reality device according to an embodiment of the disclosure may include a display engine and a waveguide image combiner according to an embodiment of the disclosure. The display engine may output image light. The waveguide image combiner may guide the image light output from the display engine, to a target area. The target area may be an eye motion box of a user.

In an embodiment of the disclosure, the augmented reality device may further include an image sensor configured to receive light diffracted by the third optical element. The third optical element and the image sensor may be sequentially arranged according to a direction in which the infrared light travels.

In an embodiment of the disclosure, the augmented reality device may further include an optical filter configured to filter light according to the wavelength range. The third optical element, the optical filter, and the image sensor may be sequentially arranged according to a direction in which infrared light travels.

In an embodiment of the disclosure, the augmented reality device may be or may include augmented reality glasses that include a left-eye element and a right-eye element which correspond to the user's left and right eyes. A display engine and a waveguide image combiner may be included in at least one of the left-eye element and the right-eye element.

In order to solve the above-mentioned technical objective, an embodiment of the disclosure provides a computer-readable recording medium on which a program to be executed on a computer is recorded.

A storage medium that may be read by a device may be provided in the form of a non-transitory storage medium. Here, “non-transitory storage medium” only means that it is a tangible device and does not include signals (e.g. electromagnetic waves). This term does not distinguish between cases where data is semi-permanently stored in a storage medium and cases where data is temporarily stored. For example, a “non-transitory storage medium” may include a buffer where data is temporarily stored.

According to an embodiment of the disclosure, methods according to various embodiments may be provided and included in a computer program product. Computer program products are commodities and may be traded between sellers and buyers. A computer program product may be distributed in the form of a machine-readable storage medium (e.g. compact disc read only memory (CD-ROM)) or distributed online (e.g., downloaded or uploaded) through an application store or directly between two user devices (e.g. smartphones). In the case of online distribution, at least a portion of the computer program product (e.g., downloadable app) may be at least temporarily stored or temporarily generated in a machine-readable storage medium, such as a memory of a manufacturer's server, an application store's server, or a relay server.

What is claimed is:

1. An electronic device comprising:
an infra-red (IR) light source configured to output infrared light;
a waveguide;
a first optical element on a first area of the waveguide, wherein the first optical element is configured to allow external light to enter the waveguide;
a second optical element on a second area of the waveguide, wherein the second optical element is configured to output the external light incident to an outside of the waveguide;
a third optical element on a third area of the waveguide, wherein the third area is different from the first area and the second area, and wherein the third optical element is configured to diffract the infrared light; and
an image sensor configured to receive the diffracted infrared light.

2. The electronic device of claim 1, wherein the third optical element and the image sensor are sequentially arranged based on a direction of the infrared light.

3. The electronic device of claim 1, wherein the third optical element is configured to diffract the infrared light such that an image is formed on an imaging surface of the image sensor.

4. The electronic device of claim 1, wherein the third optical element is configured to modulate a phase of the infrared light such that a first waveform reaches an imaging surface of the image sensor,
wherein the electronic device further comprises at least one processor configured to:
obtain a coded image based on the first waveform received by the image sensor, and
obtain user gaze information based on the coded image.

5. The electronic device of claim 4, wherein the at least one processor is further configured to:
determine one or more feature points corresponding to an eyeball based on the coded image, and
obtain the user gaze information based on the one or more feature points.

6. The electronic device of claim 4, wherein the at least one processor is further configured to:
obtain a restored image of an eye based on the coded image, and
obtain the user gaze information and biometric information based on the restored image.

7. The electronic device of claim 1, wherein the waveguide comprises a first surface and a second surface opposite to the first surface,
wherein the infrared light is incident on the first surface,
wherein the third optical element is on the first surface, and
wherein the image sensor is on the second surface.

8. The electronic device of claim 1, wherein the third optical element is disposed at a first height on the waveguide, and
wherein the image sensor is disposed at a second height different from the first height on the waveguide.

9. The electronic device of claim 7, further comprising a frame around a lower surface of the waveguide and a portion of the first surface,
wherein the image sensor is on a portion of the second surface of the waveguide, and
wherein the portion of the second surface corresponds to the portion of the first surface of the waveguide.

10. The electronic device of claim 1, further comprising a fourth optical element located on a fourth area of the waveguide, wherein the fourth optical element is configured to expand the external light propagating within the waveguide, and
wherein the fourth area is different from the third area.

11. The electronic device of claim 1, wherein the third optical element comprises:
a substrate; and
a plurality of nanostructures on the substrate, wherein the plurality of nanostructures extend perpendicular to an upper surface of the substrate.

12. The electronic device of claim 10, wherein each optical element from among the first optical element, the second optical element, the third optical element, and the fourth optical element comprises a plurality of nanostructures on the waveguide.

13. The electronic device of claim 1, further comprising an optical filter configured to filter light according to a wavelength range,
wherein the third optical element, the optical filter, and the image sensor are sequentially arranged based on a direction of the infrared light.

14. A waveguide image combiner, comprising:
a waveguide;
a first optical element on a first area of the waveguide, wherein the first optical element is configured to allow external light to enter the waveguide;
a second optical element located on a second area of the waveguide, wherein the second optical element is configured to output the external light to an outside of the waveguide; and
a third optical element on a third area of the waveguide,
wherein the third area is different from the first area and the second area, and
wherein the third optical element is configured to diffract infrared light output from a light source.

15. The waveguide image combiner of claim 14, further comprising a fourth optical element located on a fourth area of the waveguide, wherein the fourth optical element is configured to expand the external light propagating within the waveguide,
wherein the fourth area is different from the third area.

16. An augmented reality device comprising:
a display engine configured to output image light; and
a waveguide image combiner, comprising: a waveguide; a first optical element on a first area of the waveguide, wherein the first optical element is configured to allow external light to enter the waveguide; a second optical element located on a second area of the waveguide, wherein the second optical element is configured to output the external light to an outside of the waveguide; and a third optical element on a third area of the waveguide,
wherein the third area is different from the first area and the second area,
wherein the third optical element is configured to diffract infrared light output from a light source,
wherein the waveguide image combiner is configured to guide the image light to a target area, and
wherein the target area comprises an eye motion box of a user.

17. The augmented reality device of claim 16, further comprising an image sensor configured to receive light diffracted by the third optical element,
wherein the third optical element and the image sensor are sequentially arranged based on a direction of the infrared light.

18. The augmented reality device of claim 17, further comprising an optical filter configured to filter light according to a wavelength range,
wherein the third optical element, the optical filter, and the image sensor are sequentially arranged based on a direction of the infrared light.

19. The augmented reality device of claim 16, further comprising:
augmented reality glasses comprising a left-eye element corresponding to a left eye of the user, and a right-eye element corresponding to a right eye of the user,
wherein the display engine and the waveguide image combiner are included in at least one of the left-eye element and the right-eye element.
